(19) United States
(12) Patent Application Publication
(10) Pub. No.: US 2016/0093975 A1
(43) Pub. Date: Mar. 31, 2016

(54) MAGNETIC PINS

(71) Applicant: APPLE INC., Cupertino, CA (US)

(72) Inventors: Vivek Katiyar, Los Gatos, CA (US); Ibuki Kamei, San Jose, CA (US); Gregory N. Stephens, Sunnyvale, CA (US)

(73) Assignee: APPLE INC., Cupertino, CA (US)

(21) Appl. No.: 14/870,749

(22) Filed: Sep. 30, 2015

Related U.S. Application Data
(60) Provisional application No. 62/057,914, filed on Sep. 30, 2014.

(51) Int. Cl. H01R 13/62; H01F 7/08; H01F 1/147

(52) U.S. Cl. CPC H01R 13/6205; H01F 1/147; H01F 7/08

(57) ABSTRACT

Connectors that may provide an improved reliability by having a reduced tendency for damage to their contacts and may have a reduced size and complexity. One example may provide a magnetic connector having a magnetic pin. The magnetic pin may have a plunger that may remain protected in a barrel and housing when the magnetic connector is not engaged with a corresponding connector. When the magnetic connector is engaged with a corresponding connector, the plunger may be magnetically attracted to a corresponding contact on the corresponding connector and may emerge from the barrel or housing to make an electrical connection between the plunger and the corresponding contact.

### CROSS-REFERENCES TO RELATED APPLICATIONS

This application is a nonprovisional of and claims priority to U.S. patent provisional application No. 62/057,914, filed Sep. 30, 2014, which is incorporated by reference.

### BACKGROUND

The number and types of electronic devices available to consumers have increased tremendously the past few years, and this increase shows no signs of abating. Electronic devices, such as portable media players, storage devices, tablets, netbooks, laptops, desktops, all-in-one computers, wearable computing devices, cell, media, and smart phones, televisions, monitors, and other display devices, navigation systems, and other devices have become ubiquitous in recent years.

These devices often receive power and share data using various cables. These cables may have connector inserts, or plugs, on each end. The connector inserts may plug into connector receptacles on electronic devices, thereby forming one or more conductive paths between devices for signals and power. The connector inserts may be held in place in the receptacles with the help of one or more magnets.

These inserts or plugs may have contacts that mate with corresponding contacts in a receptacle. These mated contacts may form portions of electrical paths for data, power, or other types of signals. Various types of contacts may be used. One type of contact, a spring-loaded contact, may be used.

Spring-loaded contacts may include a plunger biased by a spring, such that the plunger may be depressed when contacting a second contact, then it may extend outward when disengaged from the second contact. But this arrangement may lead to a reduced reliability for the spring-loaded contact. For example, the plunger may come into contact with an object when disengaged from the second contact. This may cause the plunger to become bent or otherwise damaged. Such damage may prevent the plunger from being depressed when a second contact is engaged.

Also, the magnets used in either or both the inserts and receptacles may be fairly large. This may increase connector size and complexity.

Thus, what is needed are connectors that may provide an improved reliability by having a reduced tendency for damage to their contacts and may have a reduced size and complexity.

### SUMMARY

Accordingly, embodiments of the present invention may provide connectors that may provide an improved reliability by having a reduced tendency for damage to their contacts and may have a reduced size and complexity. An illustrative embodiment of the present invention may provide a magnetic connector having one or more magnetic pins. The magnetic pins may each have a plunger that may remain protected in a barrel and housing when the magnetic connector is not engaged with a corresponding connector. When the magnetic connector is engaged with a corresponding connector, the plunger may be magnetically attracted to a corresponding contact on the corresponding connector and may emerge from the barrel or housing to make an electrical connection between the plunger and the corresponding contact.

An illustrative embodiment of the present invention may provide a magnetic pin. The magnetic pin may include a plunger. The plunger may be located in a barrel in a passage of a housing of a connector. The barrel may have a front opening for allowing an electrical connection to the plunger. The front opening may have a lip having a top side at the front opening and an opposing bottom side. The plunger may comprise a tip extending from a base, where the base is wider than the tip. A spring may be located between the top of the base of the plunger and the bottom of the lip of the barrel. The spring may be a compression spring.

In this example, when the connector is not engaged with a corresponding connector, the spring may bias or push the plunger away from the front opening. This may protect the plunger from damage. When the connector is engaged with a corresponding connector, magnetic attraction between the plunger and a corresponding contact may overcome the bias force provided by the spring and may cause the plunger to emerge from the barrel to form an electrical connection with the corresponding connector.

In other embodiments of the present invention, other structures may be used in place of the spring. For example, an O-ring or other toroids or structures having other cross sections, such as “C” or “I” cross sections, may be used. These may be formed of elastomers, plastic, foam, or other compressible material. These springs and other structures may also provide an amount of water resistance for the connector.

In various embodiments of the present invention, the magnetic pins and corresponding contacts may include one or more magnets or they may be made of a ferromagnetic material. When a magnetic pin or corresponding contact is made of one or more magnets, the one or more magnets may be plated or sheathed in a conductive material. This conductive material may increase the current carrying capability of the magnetic pin or corresponding contact and may protect the magnets from chipping and other damage.

By including the magnets in either or both the magnetic pins or corresponding contacts, the size of the magnetic connectors may be reduced as compared to connectors where the magnets are separate from the pins and corresponding contacts. This may reduce the size, complexity, and cost of the connectors. Also, since the magnets may be located in either or both the magnetic pins and corresponding contacts, instead of being placed behind them, the magnetic attraction may be increased.

In various embodiments of the present invention the magnetic pins may be used in connector inserts, connector receptacles, or both connector inserts and receptacles. The magnetic pins may be arranged to have alternating North-South arrangements to aid in the alignment of the magnetic pins.

In various embodiments of the present invention, the components of the magnetic connectors may be formed in various ways of various materials. For example, plungers, barrels, springs, and other conductive portions of the connectors may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the receptacle and insert housings, O-rings, and other portions, may be formed using injection or other molding, 3-D printing, machining, or other manufacturing process. The nonconductive portions may be formed of silicon or silicone, rubber, hard rubber, plastic, nylon, elastomers, liquid-crystal polymers (LCPs), ceramics, or other nonconductive material or combination of materials.

Embodiments of the present invention may provide connector inserts and receptacles that may be located in, and may connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. These connector receptacles may provide pathways for signals that are compliant with various standards such as Universal Serial Bus (USB), High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connector receptacles may be used to convey power, ground, signals, test points, and other voltage, current, data, or other information.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a magnetic connector system according to an embodiment of the present invention;

FIG. 2 illustrates a connector insert and receptacle according to an embodiment of the present invention;

FIG. 3 illustrates a magnetic pin or contact according to an embodiment of the present invention;

FIG. 4 illustrates a magnetic pin or contact and a corresponding contact according to an embodiment of the present invention;

FIG. 5 illustrates a magnetic pin or contact according to an embodiment of the present invention;

FIG. 6 illustrates a magnetic pin or contact according to an embodiment of the present invention;

FIG. 7 illustrates a magnetic pin or contact according to an embodiment of the present invention; and

FIG. 8 illustrates a magnetic pin or contact according to an embodiment of the present invention.

### DESCRIPTION OF ILLUSTRATIVE EMBODIMENTS

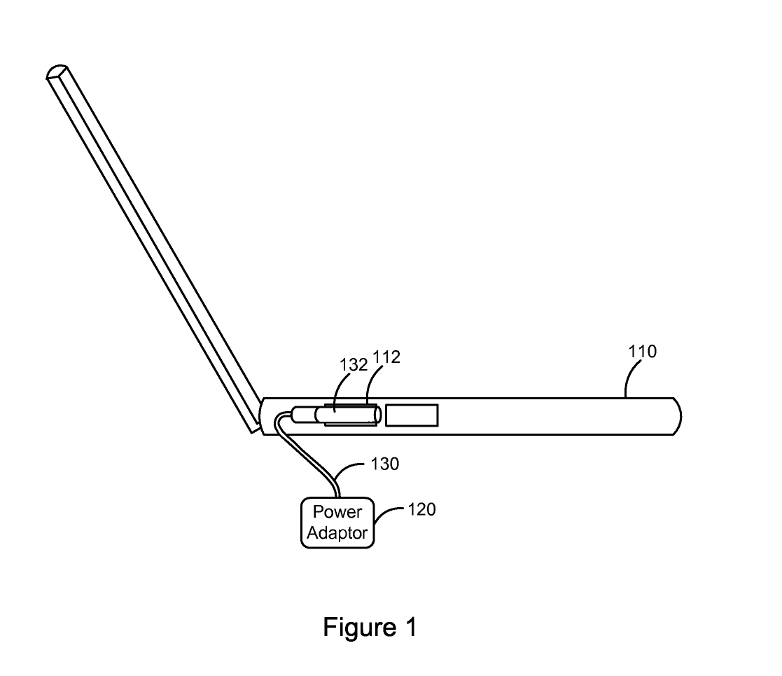

FIG. 1 illustrates a magnetic connector system according to an embodiment of the present invention. This figure, as with the other included figures, is shown for illustrative purposes and does not limit either the possible embodiments of the present invention or the claims.

This figure includes electronic device 110. In this specific example, electronic device 110 may be a laptop computer. In other embodiments of the present invention, electronic device 110 may be a portable computing device, tablet computer, desktop computer, laptop, all-in-one computer, wearable computing device, cell phone, smart phone, media phone, storage device, portable media player, navigation system, monitor, power supply, adapter, remote control device, charger, or other device.

Electronic device 110 may include a battery. The battery may provide power to electronic circuits in electronic device 110. This battery may be charged using power adapter 120. Specifically, power adapter 120 may receive power from an external source, such as a wall outlet or car charger. Power adapter 120 may convert received external power, which may be AC or DC power, to DC power, and it may provide the converted DC power over cable 130 to insert 132. In other embodiments of the present invention, plug or insert 132 may be coupled through cable 130 to another type of device. Plug 132 may be arranged to mate with receptacle 112 on electronic device 110. Power may be received at receptacle 112 from plug 132 and provided to the battery and electronic circuitry in electronic device 110. In other embodiments of the present invention, data or other types of signals may also be provided to electronic device 110 via plug or insert 132.

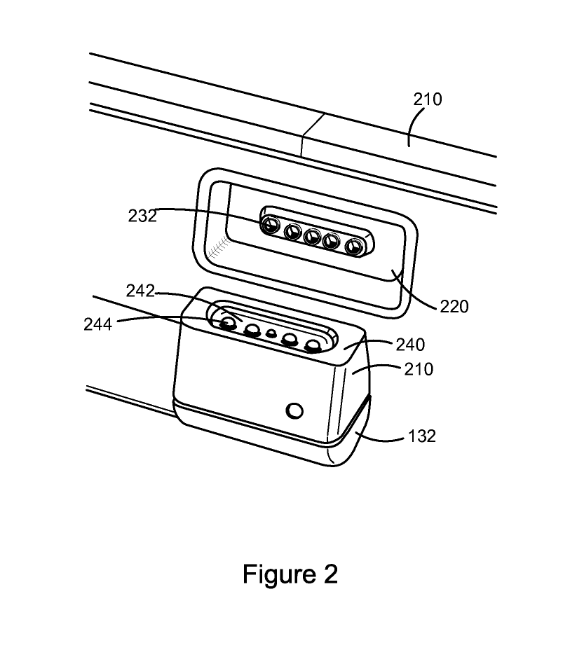

FIG. 2 illustrates a connector insert and receptacle according to an embodiment of the present invention. Connector insert 132 may include an attraction plate 210. Attraction plate 210 may include front surface 240. Front surface 240 may include opening 242 for contacts 244. In a specific embodiment of the present invention, contacts 244 may convey ground, power, and may be used to detect that a connection has been formed. In this specific example, plungers on contacts 244 are shown as emerging in opening 242, though typically these plungers may remain protected in their barrels until they are close enough to be drawn out by the magnetic attraction of corresponding contacts 232 in receptacle 220 in device 210.

In various embodiments of the present invention, contacts 244 may be magnetic pins. Examples of magnetic pins according to embodiments of the present invention are shown in the following figures.

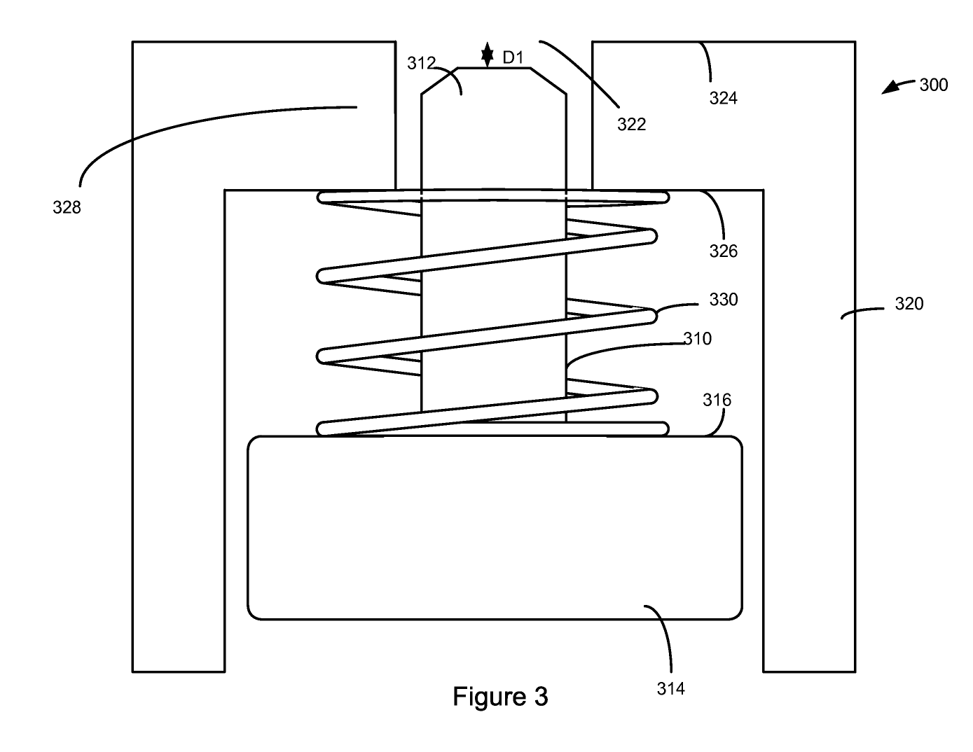

FIG. 3 illustrates a magnetic pin or contact according to an embodiment of the present invention. Magnetic pin 300 may include plunger 310 in barrel or other housing 320. Spring 330 may be located in barrel or housing 320. Barrel or housing 320 may include front opening 322. Barrel or housing 320 may include a lip 328 having a top surface 324 at the front opening 322 and a bottom surface 326 opposing the top surface 324.

Plunger 320 may include a tip 312 extending away from base 314. Base 314 may have a top surface 316. Spring 330 may be located between bottom surface 326 of lip 328 of barrel 320 and top surface 316 of base 314 of plunger 310.

In this example, a connector including magnetic pin 300 is not engaged with a corresponding connector. Accordingly, spring 330, which may be a compression spring, may push the top surface 316 of plunger portion 314 away from a bottom surface 326 of lip 328. When this happens, a tip 312 of plunger 310 may be below and may be protected by a top surface 324 of lip 328. In this example, a tip 312 of plunger 310 may be a distance D1 below top surface 324 of plunger 320. This may help to protect plunger 310 from damage when the connector employing magnetic pin 300 is not engaged with a corresponding connector. In various embodiments of the present invention, magnetic pin 300 may be located in a connector insert, a connector receptacle, or both.

Spring 330 may be plated with gold to reduce corrosion and improve electrical characteristics. Spring 330 may also be coated with in insulating or protective material such as paralyne or other conformal or other coating.

Plunger 310 may include one or more magnets. In other embodiments of the present invention, plunger 310 may be formed of a ferromagnetic material. Plunger 310 may be magnetically attracted to a corresponding contact on another connector. When plunger 310 is magnetically attracted to a contact on a corresponding connector, spring 330 may compress and tip 312 of plunger 310 may emerge from front opening 322 to make an electrical connection with a corresponding contact. An example is shown in the following figure.

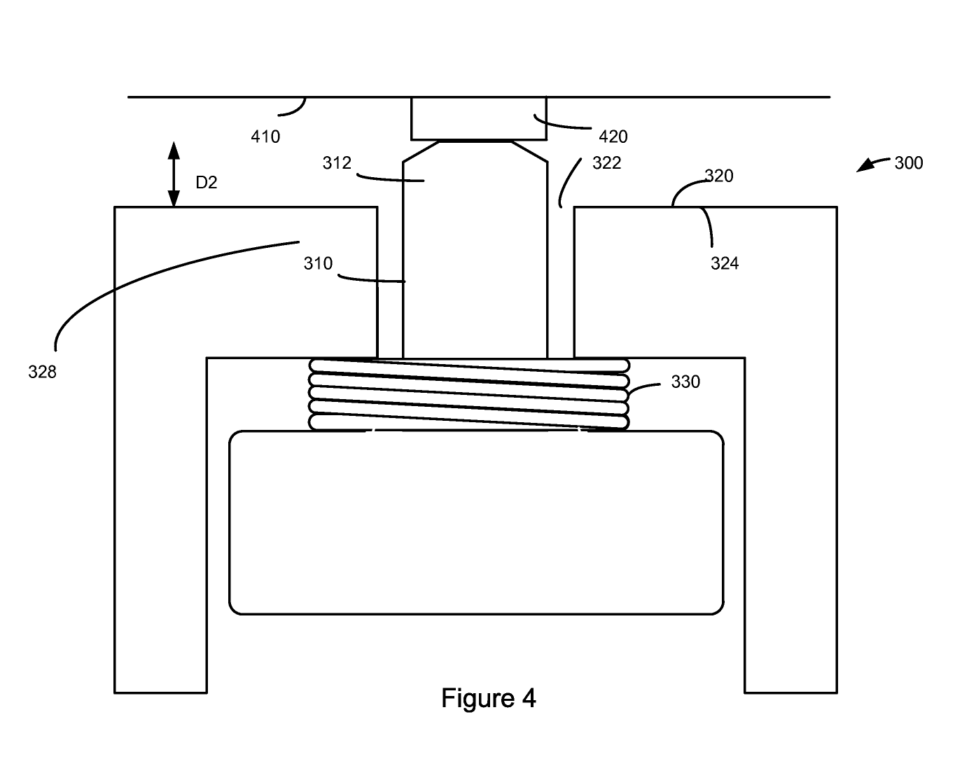

FIG. 4 illustrates a magnetic pin or contact and corresponding contact according to an embodiment of the present invention. Plunger 310 may be magnetically attracted to corresponding contact 420. This magnetic attraction may overcome the spring force provided by spring 330 and may allow plunger 310 to rise. That is, as plunger 310 is magnetically attracted to contact 410, plunger 310 may rise relative to barrel 320. This may compress spring 330, as shown. Accordingly, plunger 310 is shown as emerging from barrel or housing 320 to form an electrical connection with contact 420. Contact 420 may be located on connector 410. Connector 410 may be a connector receptacle or a connector insert. Magnetic pin or contact 300 may be located in a passage of a housing in a connector insert or a connector receptacle.

In this example, spring 330 is fully compressed and tip 312 of plunger 310 may extend above top surface 324 of tip 328 of barrel 320 by a distance D2. Accordingly, plunger 310, barrel 320, and spring 330 may be arranged such that spring 330 may compress a distance D1 plus D2 when these connectors are mated. While tip 312 of plunger is shown as being above top surface 324 when the connectors are mated, in other embodiments of the present invention, tip 312 may remain below top surface 324 when a connection is formed. For example, contact 420 may be arranged to fit in front opening 322 of barrel 320.

In other embodiments of the present invention, other compressible structures besides spring 330 may be used to bias a base 314 of plunger 312 away from front opening 322 in housing 320. Examples are shown in the following figures.

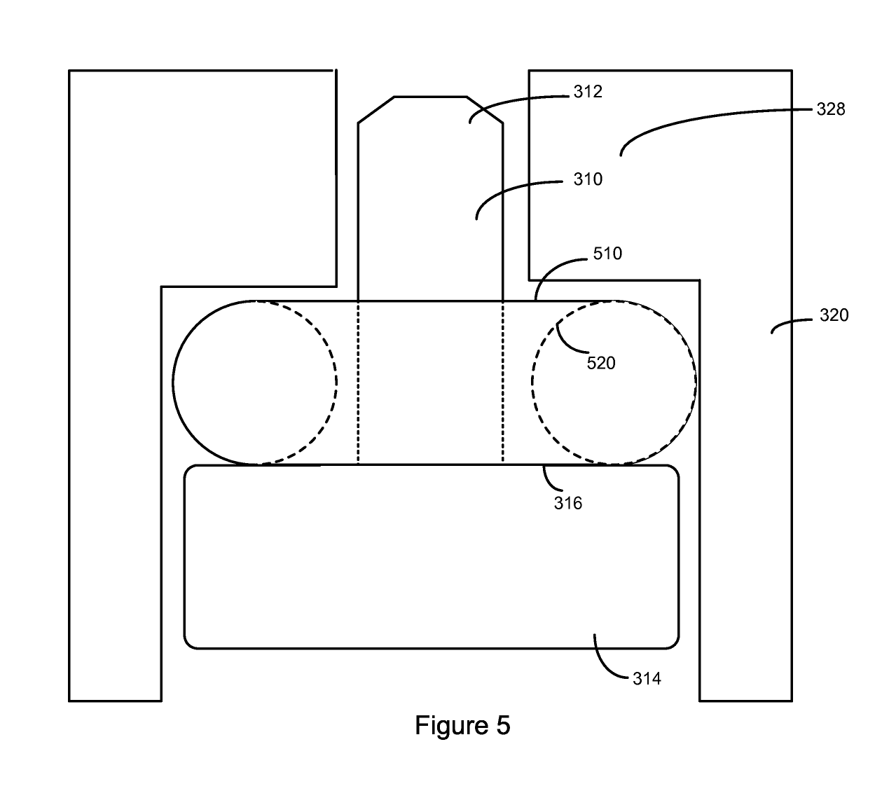

FIG. 5 illustrates a magnetic pin or contact according to an embodiment of the present invention. In this example, instead of a spring, a toroid, such as an O-ring, may be used. As before, plunger 310 may be located in barrel or housing 320. Toroid 510 may be located in barrel or housing 310 between a bottom surface 326 of lip 328 of housing 320 and a top surface 316 of a base 314 of plunger 310. As plunger 310 is magnetically attracted to a contact, base 314 may rise, thereby compressing O-ring 510. O-ring 510 may have a circular cross section 520, as shown.

In various embodiments of the present invention, it may be desirable to prevent ingress of water and other cross of fluids through these magnetic pins or contacts. Accordingly, O-ring 520 may improve water resistance by acting as a seal or gasket between plunger 310 and barrel or housing 320.

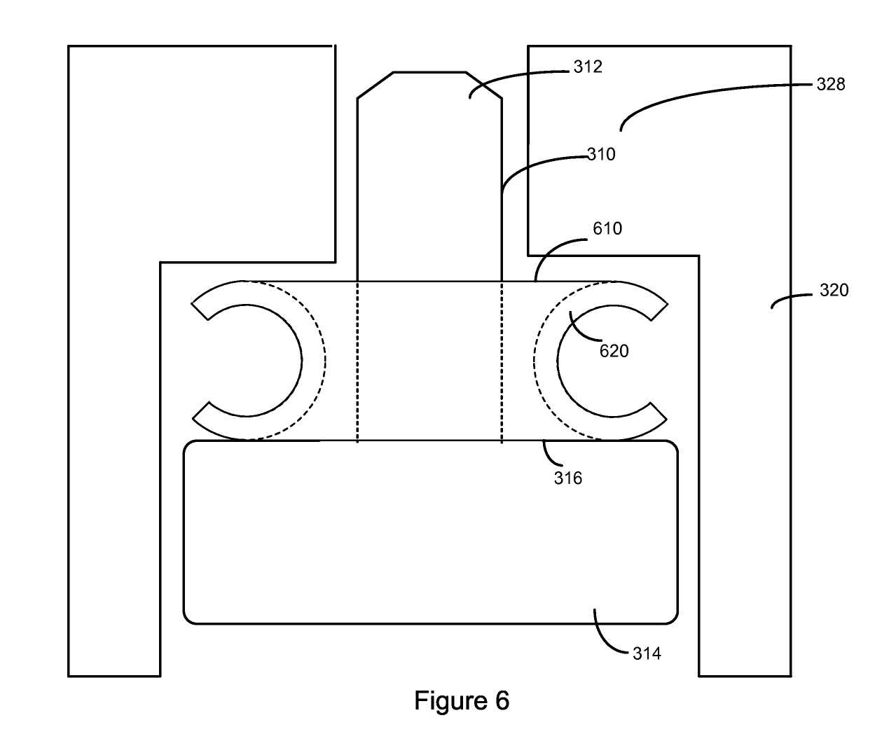

FIG. 6 illustrates a magnetic pin or contact according to an embodiment of the present invention. In this example, instead of a spring, a toroid having a noncircular cross section may be used. As before, plunger 310 may be located in barrel or housing 320. Toroid 610 may be located in barrel or housing 310 between a bottom surface 326 of lip 328 of housing 320 and a top surface 316 of a base 314 of plunger 310. As plunger 310 is magnetically attracted to a contact, base 314 may rise, thereby compressing toroid 610. Toroid 610 may have a “C” shaped cross section 620, as shown.

In various embodiments of the present invention, it may be desirable to prevent ingress of water and other cross of fluids through these magnetic pins or contacts. Accordingly, toroid 610 may improve water resistance by acting as a seal or gasket between plunger 310 and barrel or housing 320.

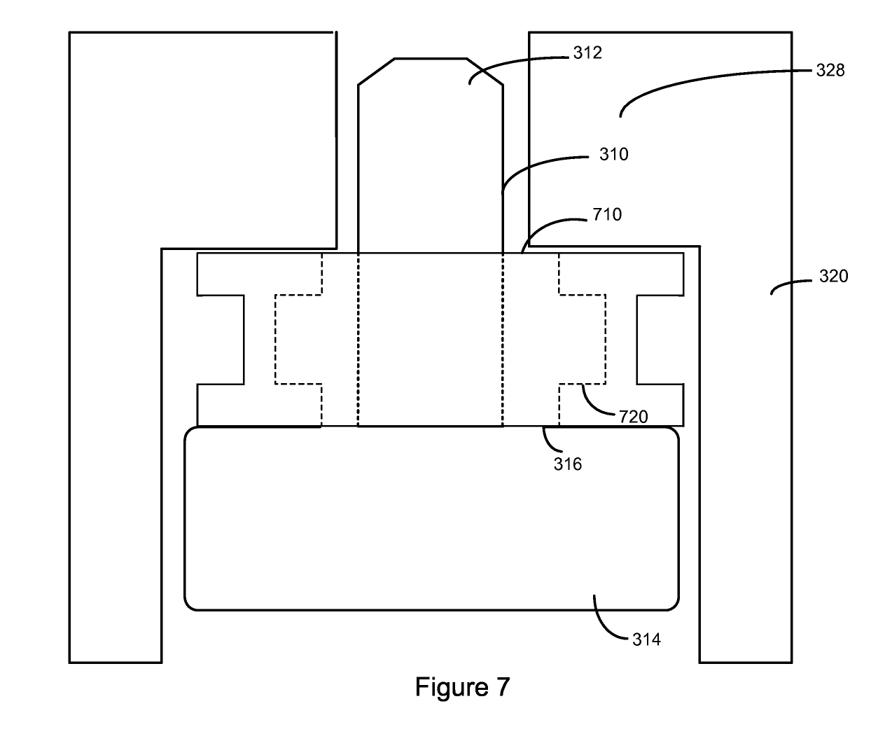

FIG. 7 illustrates a magnetic pin or contact according to an embodiment of the present invention. In this example, instead of a spring, a toroid having a noncircular cross section may be used. As before, plunger 310 may be located in barrel or housing 320. Toroid 710 may be located in barrel or housing 310 between a bottom surface 326 of lip 328 of housing 320 and a top surface 316 of a base 314 of plunger 310. As plunger 310 is magnetically attracted to a contact, base 314 may rise, thereby compressing toroid 710. Toroid 710 may have an “I” shaped cross section 720, as shown.

In various embodiments of the present invention, it may be desirable to prevent ingress of water and other cross of fluids through these magnetic pins or contacts. Accordingly, toroid 710 may improve water resistance by acting as a seal or gasket between plunger 310 and barrel or housing 320.

The plunger 310 may include magnets in various embodiments of the present invention. An example is shown in the following figure.

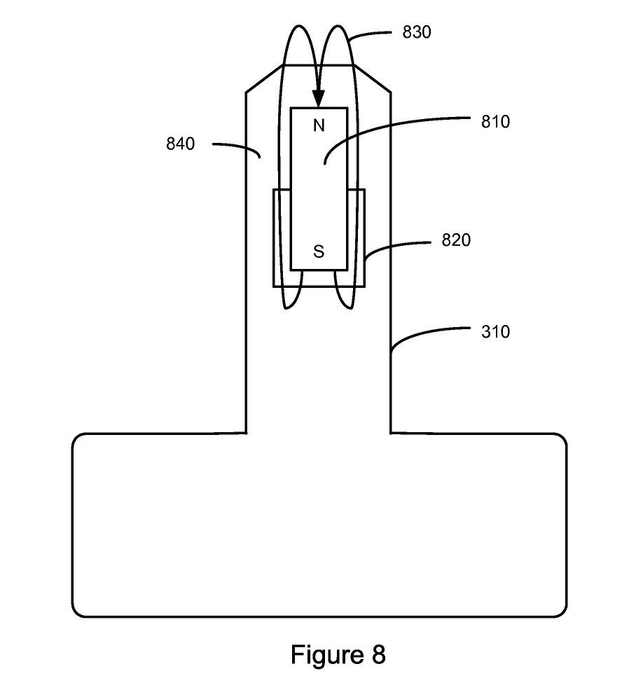

FIG. 8 illustrates a plunger for a magnetic pin according to embodiments of the present invention. Plunger 310 may include magnets 810. Backplate 820 may be used as a field guide to increase the strength of magnetic field lines 830. That is, backplate 820 may be an iron structure to focus magnetic field lines 830 to increase magnetic attraction to a corresponding contact. Again, in various embodiments of the present invention, plunger 310 may include more than one magnet. The magnet or magnets, such as magnet 810, may be coated or sheathed in a protective conductive material 840. Conductive material 840 may provide a low resistance current path through plunger 310 and may protect magnet 810 from wear and chipping.

In this example, plunger 310 may include a magnet 810 having a North end near a top. In various embodiments of the present invention, adjacent pins in a connector may have an alternating North-South arrangement (that is, the magnets may be flipped between adjacent pins or contacts.) This may aid in keeping the contacts in a connector aligned with each other.

In various embodiments of the present invention, the components of the magnetic connectors may be formed in various ways of various materials. For example, plungers, barrels, springs, and other conductive portions of the connectors may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the receptacle and insert housings, O-rings, and other portions, may be formed using injection or other molding, 3-D printing, machining, or other manufacturing process. The nonconductive portions may be formed of silicon or silicone, rubber, hard rubber, plastic, nylon, elastomers, liquid-crystal polymers (LCPs), ceramics, or other nonconductive material or combination of materials.

Embodiments of the present invention may provide connector inserts and receptacles that may be located in, and may connect to, various types of devices, such as portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. These connector receptacles may provide pathways for signals that are compliant with various standards such as Universal Serial Bus (USB), High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connector receptacles may be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A magnetic pin comprising:
a barrel having a front opening, the front opening having a lip, the lip having a top surface at a front of the barrel and a bottom surface below the top surface;
a plunger housed in the barrel, the plunger having a tip extending from a top surface of a base; and
a spring coiled around the tip of the plunger and between the bottom surface of the lip of the barrel and the top of the base of the plunger.

2. The magnetic pin of claim 1 wherein the spring is a compression spring.

3. The magnetic pin of claim 2 wherein the plunger is formed of a magnetic material.

4. The magnetic pin of claim 2 wherein the plunger is formed of a ferromagnetic material.

5. The magnetic pin of claim 2 wherein the plunger comprises a rare-earth magnet.

6. The magnetic pin of claim 5 wherein the rare-earth magnet is covered in a conductive sheath.

7. The magnetic pin of claim 1 wherein the spring is gold-plated.

8. A magnetic pin comprising:
a barrel having a front opening, the front opening having a lip, the lip having a top surface at a front of the barrel and a bottom surface below the top surface;
a plunger housed in the barrel, the plunger having a tip extending from a top surface of a base; and
an elastic structure around the tip of the plunger and between the bottom surface of the lip of the barrel and the top of the base of the plunger.

9. The magnetic pin of claim 8 wherein the elastic structure is an O-ring.

10. The magnetic pin of claim 8 wherein the elastic structure is a C-shaped toroid.

11. The magnetic pin of claim 8 wherein the elastic structure is an I-shaped toroid.

12. The magnetic pin of claim 8 wherein the elastic structure is formed of an elastomer.

13. The magnetic pin of claim 8 wherein the plunger comprises a rare-earth magnet.

14. The magnetic pin of claim 13 wherein the rare-earth magnet is covered in a conductive sheath.

15. A magnetic connector comprising:
a housing having a number of passages;
a plurality of magnetic pins each disposed in a passage in the housing, each magnetic pin comprising:
a barrel having a front opening, the front opening having a lip, the lip having a top surface at a front of the barrel and a bottom surface below the top surface;
a plunger housed in the barrel, the plunger having a tip extending from a top surface of a base; and
a spring coiled around the tip of the plunger and between the bottom surface of the lip of the barrel and the top of the base of the plunger.

16. The magnetic connector of claim 15 wherein the spring is a compression spring.

17. The magnetic connector of claim 15 wherein the plunger comprises a rare-earth magnet.

18. The magnetic connector of claim 17 wherein the rare-earth magnet is covered in a conductive sheath.

19. The magnetic connector of claim 15 wherein the magnetic connector is an insert.

20. The magnetic connector of claim 15 wherein the magnetic connector is a receptacle.
